(19) United States
(12) Patent Application Publication
(10) Pub. No.: US 2017/0030582 A1
(43) Pub. Date: Feb. 2, 2017

(54) COMBUSTOR FOR A GAS TURBINE ENGINE

(71) Applicant: ROLLS-ROYCE plc, London (GB)

(72) Inventors: Ahmad RAZAK, Bristol (GB); Bryce D. CONDUIT, Derby (GB)

(73) Assignee: ROLLS-ROYCE plc, London (GB)

(21) Appl. No.: 15/216,433

(22) Filed: Jul. 21, 2016

(30) Foreign Application Priority Data
Jul. 27, 2015 (GB) 1513157.6

(51) Int. Cl. F23R 3/00; F02C 3/14; F02C 3/04

(52) U.S. Cl. CPC F23R 3/007; F02C 3/04; F02C 3/14; F23R 2900/00005

(57) ABSTRACT

A combustor for a gas turbine engine which includes a flame tube made of a ceramic material and a metal casing which surrounds the flame tube. The combustor further includes a thermal insulation layer between the flame tube and the casing which protects the casing from the high temperatures produced by combustion in the combustor and a loading structure which holds the flame tube in a state of axial and radial compression at all engine operating conditions.

### FIELD OF THE INVENTION

The present invention relates to a combustor for a gas turbine engine including a flame tube made of a ceramic material.

### BACKGROUND

Peak gas temperatures above 2100° C. and average gas temperatures of about 1500° C. can be produced by combustion in a gas turbine engine combustor, with reheat combustors experiencing particularly high gas temperatures. These temperatures can exceed the melting points of the materials that form the combustor, such that combustor cooling becomes necessary.

One method of cooling a reheat combustor is to direct exhaust gases from upstream of the combustor through holes in the combustor wall to produce a protective cooling film of gas. However, the exhaust gases themselves are at relatively high temperatures, and thus the protective effect of such a cooling film may be limited.

Another option is to create a cooling film from air bled from the compressor section of the engine. In this case the cooling film can be at a lower temperature, but bleeding air from the compressor imposes significant performance penalties, such as increased specific fuel consumption and reduced specific thrust/power. These penalties can be significant, especially in reheat combustors where the cooling demands can be greater than those of main combustors.

A combustor is therefore required which has a reduced cooling demand.

### SUMMARY

In general terms the present invention provides a combustor with a flame tube made of a ceramic material which can reduce the combustor cooling demand.

Accordingly, in a first aspect, the present invention provides a combustor for a gas turbine engine, including:
a flame tube made of a ceramic material;
a metal casing which surrounds the flame tube; and
a thermal insulation layer between the flame tube and the casing which protects the casing from the high temperatures produced by combustion in the combustor;
wherein the combustor further includes a loading structure which holds the flame tube in a state of axial and radial compression at all engine operating conditions.

In general, ceramic materials have excellent high temperature properties, such as high strength in compression, low thermal conductivity, low thermal expansion and high temperature environmental resistance, to make components and are thus usable at higher temperatures than metals. Accordingly, the ceramic flame tube can withstand higher temperatures than many conventional metal flame tubes, which allows the combustor cooling demand to be reduced. However, ceramic materials are relatively brittle, typically having a low fracture toughness. Advantageously, holding the flame tube in a state of axial and radial compression at all engine operating conditions prevents the tube from being subjected to tensional stresses. Thus, despite the brittle nature of the ceramic, the initiation and subsequent propagation of cracks through the flame tube can be prevented.

In a second aspect, the present invention provides a gas turbine engine having a combustor according to the first aspect.

Optional features of the invention will now be set out. These are applicable singly or in any combination with any aspect of the invention.

The flame tube may be made of aluminium oxide or silicon carbide ceramic matrix composite. The flame tube may have a barrier coating inside the flame tube (i.e. an EBC—Environmental Barrier Coating) to increase oxidation and corrosion resistance. The barrier coating may be formed of yttrium or dysprosium stabilized zirconia.

The thermal insulation layer may be a ceramic-based blanket material. Advantageously, such a layer can be low density.

The thermal insulation layer may be made of any one or any combination of oxides selected from the group consisting of alumina, zirconia, silica, iron oxide, titanium oxide, calcium oxide, potassium oxide and sodium oxide.

The loading structure may also secure the thermal insulation layer in position between the flame tube and the casing.

The loading structure may include a plurality of circumferentially spaced ties which extend axially from end to end of the flame tube for connection to adjacent engine components, the ties being loaded in tension to hold the flame tube in the state of axial compression at all engine operating conditions. The ties may connect to respective flanges of the adjacent engine components. The ties may be made of metal. The ties may be protected by the thermal insulation layer from the high temperatures produced by combustion in the combustor.

The loading structure may include one or more bands which wrap circumferentially around the flame tube such that the bands hold the flame tube in the state of radial compression at all engine operating conditions. The bands may also wrap around the thermal insulation layer. In this way, the bands can also be protected by the thermal insulation layer from the high temperatures produced by combustion in the combustor. The bands may be made of metal.

Although the bands are shown as not having an axial component it is possible for them to be helically arranged. The bands may be narrow i.e. in round or flat cable form which will allow the bands to be wrapped in continuously along the length of the flame tube. The wrapping may extend from the front of the flame tube to the rear or from the rear of the flame tube to the front or both. Other configurations i.e. starting from a mid-point may also be possible. The cables may be metal or ceramic and may be woven.

The loading structure may include a plurality of circumferentially and axially distributed struts which project radially outwardly from the flame tube to engage the casing or locations on the tie-bolts, the struts being loaded in compression to hold the flame tube in the state of radial compression at all engine operating conditions. The struts may slidingly engage with the casing to accommodate differential thermal movement between the casing and the flame tube. The struts may be made of ceramic. The respective areas of engagement between the struts and the surrounding casing may be lubricated with a dry lubricant. Further, the dry lubricant may be graphite. The flame tube may be split into two halves along a plane containing the axis of the tube, sealant being provided along the join between the two halves.

The combustor may have cooling air passages to provide cooling air (e.g. redirected exhaust gas or compressor bleed air) to the loading structure.

However, the combustor may have no cooling air passages for providing cooling air to the flame tube, i.e. the flame tube may be uncooled.

The combustor may further include fuel injectors at the upstream end of the flame tube.

The combustor may be a reheat combustor.

The flame tube may have a circular cross-section, e.g. if it is in the exhaust section of the engine. According to another option, the flame tube may have an annular cross-section, e.g. if it has to surround an engine shaft. In this case both the inner and the outer walls of the flame tube can be made of the ceramic material, the thermal insulation layer being between the outer wall of the flame tube and the casing.

### BRIEF DESCRIPTION OF THE DRAWINGS

Embodiments of the invention will now be described by way of example with reference to the accompanying drawings in which:

FIG. 1 shows schematically a gas turbine engine;

FIG. 2 shows schematically a longitudinal cross-section through an annular combustor;

FIG. 3a shows schematically the end view of the combustor of FIG. 2 from the downstream end;

FIG. 3b shows schematically the end view of the combustor of FIG. 2 from the upstream end; and

FIG. 4 shows schematically a longitudinal cross-section through another annular combustor.

### DETAILED DESCRIPTION AND FURTHER OPTIONAL FEATURES

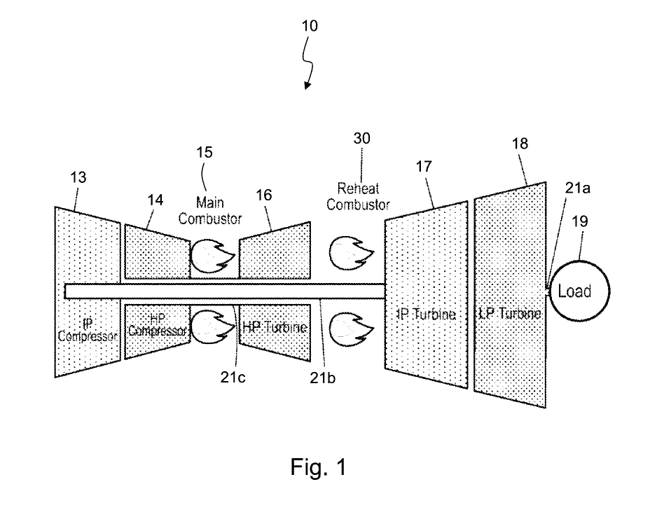

With reference to FIG. 1, a gas turbine engine incorporating the invention is generally indicated at 10. The engine comprises, in axial flow series, an intermediate pressure compressor 13, a high-pressure compressor 14, main combustion equipment 15, a high-pressure turbine 16, reheat combustion equipment 30, an intermediate pressure turbine 17, and a low-pressure turbine 18.

During operation, air entering an intake of the engine is delivered into the intermediate-pressure compressor 13. The intermediate-pressure compressor 13 compresses the air flow directed into it before delivering that air to the high-pressure compressor 14 where further compression takes place.

The compressed air exhausted from the high-pressure compressor 14 is directed into the main combustion equipment 15 where it is mixed with fuel and the mixture combusted. The resultant hot combustion products expand through, and thereby drive the high pressure turbine 16. The combustion products are then directed to the reheat combustion equipment 30 where they are mixed with further fuel to produce further combustion. The reheat combustion products expand through and drive the intermediate and low-pressure turbines 17, 18 before being exhausted through a nozzle, e.g. to provide at least some propulsive thrust. The high, intermediate and low-pressure turbines respectively drive the high and intermediate-pressure compressors 14, 13 and a load 19 by suitable interconnecting shafts 21a-c. The load 19 may be, for example, a propulsive fan, a propeller, an electrical generator, a pipeline compressor or a pump.

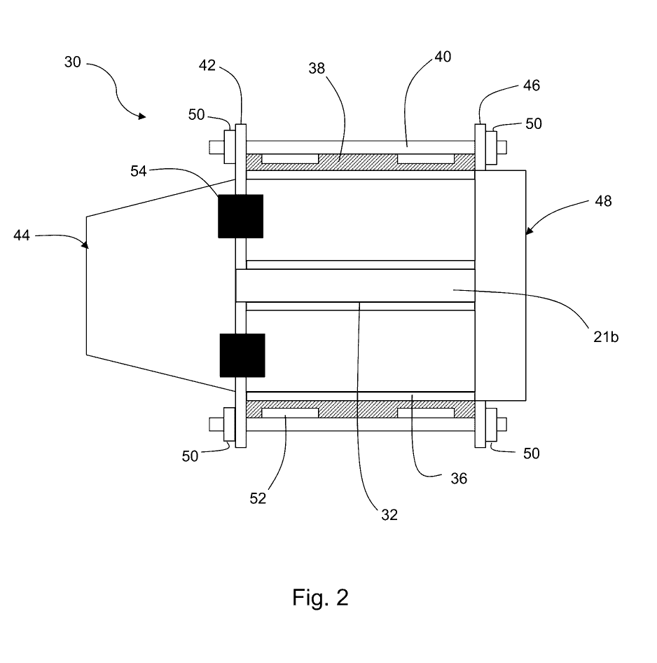

FIG. 2 shows schematically a longitudinal cross-section through the reheat combustor 30, which has an annular flame tube with two walls. An inner wall 32 surrounds the engine shaft 21b and a coaxial outer wall 36 surrounds the inner wall to define an annular volume therebetween in which combustion takes place. Both of the walls of the flame tube can be made of aluminium oxide, however other ceramic materials, such as silicon carbide ceramic matrix composite, may be used. Advantageously, aluminium oxide can withstand and remain usable at higher temperatures than many of the metals conventionally used to form flame tubes. The flame tube can therefore withstand higher temperatures than conventional flame tubes, reducing or eliminating the cooling demand of the combustor. An optional EBC within the flame tube can further increase the operating temperature capability. In this way, less cooling air or no cooling air may need to be bled from the compressors, increasing engine efficiency.

A thermal insulation layer 38 is located between the outer wall 36 and a surrounding metal casing (not shown) of the combustor. The insulation layer may be made of a zirconia-based blanket material, although other ceramic blanket materials can be used, and insulates the casing from the high temperatures produced by reheat combustion. Although not shown in the drawings, the insulation layer may further extend over the ends of the flame tube to protect adjacent components from the high temperatures. For example, alumina and SiC-based components can be at risk of reacting together to form mullite at high temperatures, but by interposing a blanket made from e.g. zirconia therebetween this reaction can be supressed.

The flame tube is held in a state of axial and radial compression at all engine operating conditions by a loading structure, which also serves to secure the thermal insulation layer 38 in position between the outer wall 36 and the surrounding metal casing of the combustor. The loading structure includes a plurality of metal ties 40 which are spaced circumferentially around the outer wall 36. The ties are connected at the upstream end to an upstream flange 42, which is part of a diffuser 44, and at the downstream end to a downstream flange 46, which can be part of a nozzle guide vane assembly 48.

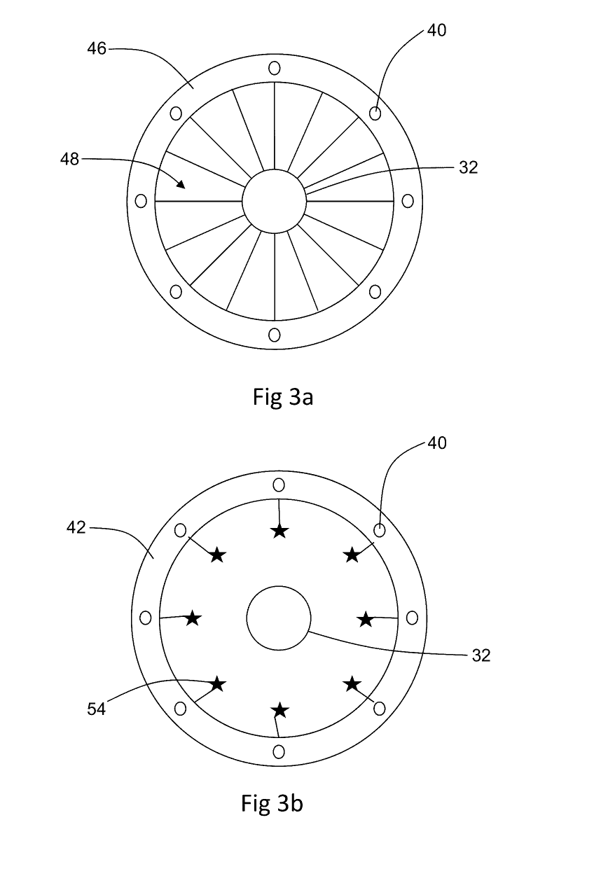

The nozzle guide vane assembly 48 can also be seen in FIG. 3(a) which is a schematic view of the combustor 30 from the downstream end. In particular, FIG. 3(a) shows the location of the guide vanes of the assembly in the annular volume between the inner wall 32 of the flame tube and the downstream flange 46. The flange may be made of the nozzle guide vane material and, like the guide vanes, may be externally and/or internally cooled to ensure satisfactory operation in the high temperatures downstream of the combustor.

With reference again to FIG. 2, the ties 40 pass through holes in the upstream and downstream flanges 42, 46 and are tightened by a plurality of nuts 50 to place the ties 40 into a state of tension such that the flame tube is held in the state of axial compression, sandwiched between the flanges 42, 46, which also seal the ends of the flame tube.

Typically both flanges 42, 46 are non-integral with the flame tube. However, if one flange is non-integral and one is integral the ties 40 can still be effective at placing the flame tube in the state of axial compression.

The loading structure further includes metal bands 52 that are wrapped circumferentially around the thermal insulation layer 38 and the flame tube such that the bands are flush with the surface of the insulation layer and such that the tube is subjected to a state of radial compression at all engine operating conditions. In particular, the high pressures in the flame tube during combustion operation produce an outward pressure on the outer wall 36 of the flame tube which if left un-resisted by the bands could result in a state of radial tension in the outer wall. In contrast, the pressures in the flame tube apply an inward pressure to the inner wall 32 which increases a state of radial compression in the inner wall. The bands also help to secure the thermal insulation layer in position.

Advantageously, by subjecting the ceramic flame tube and insulating layer to a state of axial and radial compression at all engine operating conditions, the development of tension and the subsequent initiation and propagation of cracks through the relatively brittle ceramic material of the flame tube can be prevented. Further, by separating the outer wall 36 of the flame tube from the ties 40 and the bands 52 with the thermal insulation layer, the ties and bands can be protected from the high temperatures produced by combustion in the flame tube.

At the upstream end of the flame tube of the combustor 30 are located a plurality of fuel injectors 54 for injecting a finely atomised spray of liquid fuel or gaseous fuel evenly into the annular volume of the flame tube. FIG. 3(b) shows schematically an end view of the combustor from the upstream end, and in particular the circumferential arrangement of these injectors. Although not shown, another option is to distribute fuel injectors along the length of the flame tube.

The injectors, and the fuel lines which supply them, may be made from materials, other than the above mentioned ceramics, which can withstand the high temperatures of the combustor. Any, fuel channels and injection points formed in the ceramic flame tube can be configured such that the flame tube remains in the state of axial and radial compression under all operating conditions, including when fuel under pressure flows through these channels.

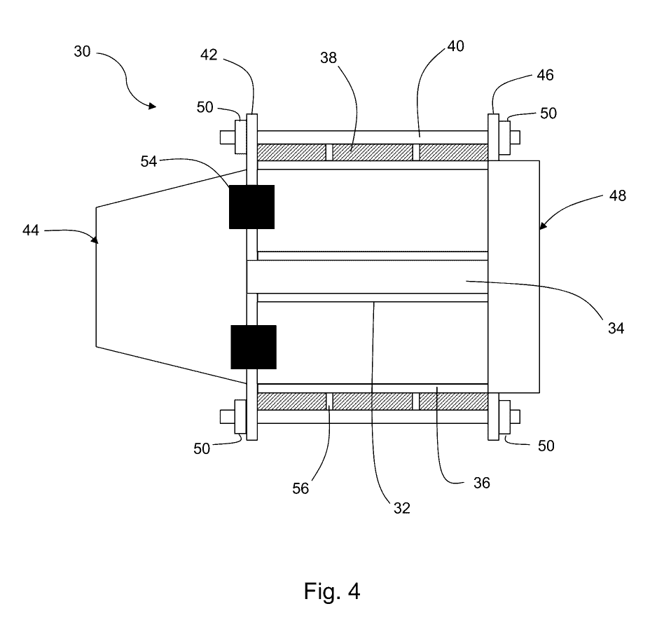

FIG. 4 shows schematically a longitudinal cross-section through a variant of the reheat combustor 30. Similar or equivalent features have the same reference numbers in FIGS. 2 and 4.

The loading structure of the variant reheat combustor 30 of FIG. 4 includes, instead of the metal bands 52 of FIG. 2, a plurality of ceramic struts 56 which are circumferentially and axially distributed over the outer wall 36 of the flame tube. Moreover, the flame tube is split into two halves along a plane containing the axis of the tube. Grout/sealant is injected along the walls 32, 36 of the tube where the two halves meet. The struts project radially outwardly from the outer wall 36 to engage with the surrounding casing or a further casing (not shown) that may encircle the insulation, such that they are in radial compression. During combustion operation, the high pressures in the flame tube result in outward (radial) movement of the two halves of the outer wall of the flame tube and this results in the flame tube and the struts being subjected to increased radial compression as the free end of the struts press further against the surrounding casing. In this way the struts hold the flame tube in a state of radial compression under all engine operating conditions. A dry lubricant, such as graphite, can be applied at the areas of contact between the casing and the struts 56 helping the struts to move relative to the casing to accommodate differential thermal movement between the casing and the loading structure. Advantageously, as the struts extend directly from the outer wall 36, the thermal insulation layer is not compressed by the struts as the outer wall expands.

In an alternative arrangement the struts engage with the tie-bars that are used to place the flame tube in axial compression.

The struts may taper in a straight or curved manner from the flame tube to increase the area over which they extend, and the localised stress distribution on the flame tube. The struts may be rigid or have some resilience in the radial direction in which they extend,

Although not shown in the drawings, the combustor may further include cooling air passages which allow cooling air, such as redirected exhaust gas or bled compressed air, to be circulated around the loading structure. However, the flame tube itself may be uncooled.

While the invention has been described in conjunction with the exemplary embodiments described above, many equivalent modifications and variations will be apparent to those skilled in the art when given this disclosure. For example, the invention is not limited to annular combustion systems but can be used in the exhaust section of the engine where typically it would have a circular cross-section. Moreover, the invention is not limited to reheat combustor applications. For example, in a gas turbine context, the combustor may be a main combustor. Accordingly, the exemplary embodiments of the invention set forth above are considered to be illustrative and not limiting. Various changes to the described embodiments may be made without departing from the spirit and scope of the invention.

1. A combustor for a gas turbine engine, including:
a flame tube made of a ceramic material;
a metal casing which surrounds the flame tube; and
a thermal insulation layer between the flame tube and the casing which protects the casing from the high temperatures produced by combustion in the combustor;
wherein the combustor further includes a loading structure which holds the flame tube in a state of axial and radial compression at all engine operating conditions; wherein the loading structure includes one or more bands which wrap circumferentially around the flame tube such that the bands hold the flame tube in the state of radial compression at all engine operating conditions.

2. A combustor according to claim 1, wherein the flame tube is made of aluminium oxide or silicon carbide ceramic matrix composite.

3. A combustor according to claim 1, wherein the thermal insulation layer is a ceramic-based blanket material.

4. A combustor according to claim 1, wherein the thermal insulation layer is made of any one or any combination of oxides selected from the group consisting of alumina, zirconia, silica, iron oxide, titanium oxide, calcium oxide, potassium oxide and sodium oxide.

5. A combustor according to claim 1, wherein the loading structure includes a plurality of circumferentially spaced ties which extend axially from end to end of the flame tube for connection to adjacent engine components, the ties being loaded in tension to hold the flame tube in the state of axial compression at all engine operating conditions.

6. A combustor according to claim 5, wherein the ties are also protected by the thermal insulation layer from the high temperatures produced by combustion in the combustor.

7. A combustor according to claim 1, wherein the one or more bands wrap around the thermal insulation layer such that the thermal insulation layer is held in compression against the flame tube.

8. A combustor according to claim 7, wherein the bands are formed of metal or ceramic fibres.

9. A combustor for a gas turbine engine, including:
a flame tube made of a ceramic material;
a metal casing which surrounds the flame tube; and
a thermal insulation layer between the flame tube and the casing which protects the casing from the high temperatures produced by combustion in the combustor;
wherein the combustor further includes a loading structure which holds the flame tube in a state of axial and radial compression at all engine operating conditions; wherein the loading structure includes a plurality of circumferentially and axially distributed struts which project radially outwardly from the flame tube to engage the casing or an intermediary casing, the struts being loaded in compression to hold the flame tube in the state of radial compression at all engine operating conditions.

10. A combustor according to claim 9 wherein the struts are enclosed by the thermal insulation.

11. A combustor for a gas turbine engine, including:
a flame tube made of a ceramic material;
a metal casing which surrounds the flame tube; and
a thermal insulation layer between the flame tube and the casing which protects the casing from the high temperatures produced by combustion in the combustor;
wherein the combustor further includes a loading structure which holds the flame tube in a state of axial and radial compression at all engine operating conditions; wherein the loading structure includes a plurality of circumferentially spaced ties which extend axially from end to end of the flame tube for connection to adjacent engine components, the ties being loaded in tension to hold the flame tube in the state of axial compression at all engine operating conditions; and wherein the loading structure includes a plurality of circumferentially and axially distributed struts which project radially outwardly from the flame tube to engage the circumferentially spaced ties, the struts being loaded in compression to hold the flame tube in the state of radial compression at all engine operating conditions.

12. A combustor according to claim 9, wherein the struts slidingly engage with the casing to accommodate differential thermal movement between the casing and the flame tube.

13. A combustor according to claim 1 further including cooling air passages to provide cooling air to the loading structure.

14. A combustor according to claim 1 further including fuel injectors at the upstream end of the flame tube.

15. A combustor according to claim 1, wherein the combustor is a reheat combustor.
